(19) United States
(12) Patent Application Publication
(10) Pub. No.: US 2026/0209561 A1
(43) Pub. Date: Jul. 23, 2026

(54) PROTECTIVE TAPE FOR WIRE HARNESS

(71) Applicant: Yazaki Corporation, Tokyo (JP)

(72) Inventor: Naoya TAKAHASHI, Shizuoka (JP)

(73) Assignee: Yazaki Corporation, Tokyo (JP)

(21) Appl. No.: 19/570,350

(22) Filed: Mar. 18, 2026

Related U.S. Application Data
(63) Continuation of application No. PCT/JP2025/000154, filed on Jan. 7, 2025.

(30) Foreign Application Priority Data
Feb. 6, 2024 (JP) 2024-016562

(51) Int. Cl. C09J 7/24; C09J 7/38

(52) U.S. Cl. CPC C09J 7/245; C09J 7/383; C09J 2203/326; C09J 2301/302; C09J 2427/006

(57) ABSTRACT

Provided is a protective tape for a wire harness excellent in tape winding workability, suppression of tape end peeling, and abrasion resistance. A protective tape for a wire harness includes a base material and a pressure-sensitive adhesive layer formed on the base material, in which the base material contains a thermoplastic resin and has a thickness of 120 μm or more and 190 μm or less, a 10% modulus (N/19 mm width) is 12.5 or more and 18.5 or less, and an unwinding adhesive force (N/19 mm width) is 0.8 or more and 4.5 or less.

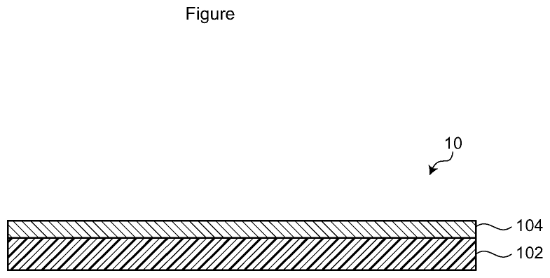

### CROSS-REFERENCE TO RELATED APPLICATION(S)

This application is a continuation application of International Application PCT/JP2025/000154, filed on Jan. 7, 2025 which claims the benefit of priority from Japanese Patent Application No. 2024-016562 filed on Feb. 6, 2024 and designating the U.S., the entire contents of which are incorporated herein by reference.

### BACKGROUND OF THE INVENTION

### 1. Field of the Invention

The present invention relates to a protective tape for a wire harness.

### 2. Description of the Related Art

Japanese Patent Application Laid-open No. 2018-178008 describes a pressure-sensitive adhesive resin tape in which a pressure-sensitive adhesive layer is formed of a pressure-sensitive adhesive composition, as a protective tape for a wire harness in which a pressure-sensitive adhesive layer is provided on a resin base material. It is also described that the pressure-sensitive adhesive composition is obtained by blending 40 to 120 parts by mass of a rosin type tackifying resin having a softening point of 130° C. to 135° C. and 1 to 15 parts by mass of a low molecular weight polyisoprene having a weight average molecular weight of 15000 to 40000 with respect to 100 parts by mass (nonvolatile content) of a main agent composed of a mixture of a natural rubber latex and a synthetic rubber latex.

However, in the protective tape for a wire harness of Japanese Patent Application Laid-open No. 2018-178008, it was not possible to achieve well-balanced improvement in all of tape winding workability, suppression of tape end peeling, and abrasion resistance.

### SUMMARY OF THE INVENTION

An object of the present invention is to provide a protective tape for a wire harness excellent in tape winding workability, suppression of tape end peeling, and abrasion resistance.

### Solution to Problem

A protective tape for a wire harness according to the present invention is characterized by including a base material; and a pressure-sensitive adhesive layer formed on the base material, wherein the base material contains a thermoplastic resin and has a thickness of 120 μm or more and 190 μm or less, a 10% modulus (N/19 mm width) is 12.5 or more and 18.5 or less, and an unwinding adhesive force (N/19 mm width) is 0.8 or more and 4.5 or less.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

The FIGURE is a cross-sectional view of a protective tape for a wire harness according to an embodiment.

### DETAILED DESCRIPTION OF THE PREFERRED EMBODIMENTS

Hereinafter, a protective tape for a wire harness according to an embodiment of the present invention will be described in detail with reference to the drawings. Note that the invention is not limited by the embodiment. In addition, constituent elements in the following embodiment include those that can be easily assumed by those skilled in the art or those that are substantially the same.

### Embodiment

An embodiment will be described with reference to the FIGURE. The present embodiment relates to a protective tape for a wire harness. The FIGURE is a protective tape for a wire harness according to an embodiment.

A protective tape 10 for a wire harness of the present embodiment is suitably used for a wire harness for an automobile. The protective tape 10 for a wire harness of the present embodiment is used when binding the wire harness or when fixing a protective member for a wire harness to the wire harness. Specifically, it can be used by being wound around a binding position or a fixing position.

The protective tape 10 for a wire harness of the present embodiment includes a base material 102 and a pressure-sensitive adhesive layer 104 formed on the base material 102. In addition, the base material 102 contains a thermoplastic resin and has a thickness of 120 μm or more and 190 μm or less. Further, a 10% modulus (N/19 mm width) is 12.5 or more and 18.5 or less, and an unwinding adhesive force (N/19 mm width) is 0.8 or more and 4.5 or less. According to the protective tape 10 for a wire harness of the present embodiment, it is possible to achieve well-balanced improvement in all of tape winding workability, suppression of tape end peeling, and abrasion resistance.

Conventionally, in a wire harness, a thick polyvinyl chloride (PVC) tape, a polypropylene (PP) tape, or the like having abrasion resistance has been used for convergence and protection of electric wires. As an issue of the thick tape, there is a problem that an end of the tape after binding is peeled off. In view of the problem, the tape has been attempted to improve peeling by increasing the unwinding adhesive force of the tape, but on the other hand, the tape winding workability at the time of binding the electric wires deteriorates. Alternatively, measures have been taken to fix the peeled portion again with a thin tape, but material costs and man-hours are incurred. Therefore, there has been a demand for a tape which does not cause tape end peeling and has good tape winding workability.

However, when the unwinding adhesive force is lowered in consideration of workability at the time of winding the tape, the tape end is peeled off after being wound around the electric wires. Two factors that cause end peeling include low adhesive force and shrinkage of a base material after the tape is peeled off. For this reason, the present inventors have found that when the adhesive force is too high, a burden on the operator increases, and thus it is needed to ensure that the adhesive force is not too high and to use a base material that is less likely to shrink (less likely to deform). Furthermore, the present inventors have found that by searching for the 10% modulus of the tape, the range of the unwinding adhesive force, and the range of the thickness of the base material, a tape that does not cause tape end peeling, has good tape winding workability, and is also excellent in abrasion resistance can be obtained.

In other words, the base material 102 is a film using a thermoplastic resin. As the thermoplastic resin, at least one selected from the group consisting of polyvinyl chloride (PVC), polypropylene, and polyethylene is suitably used. Among them, polyvinyl chloride is more preferably used.

The pressure-sensitive adhesive layer 104 is usually formed of a pressure-sensitive adhesive composition. Examples of a main agent of the pressure-sensitive adhesive composition include, as rubber-based materials, natural rubber latex such as unmodified natural rubber latex or acrylic-modified natural rubber latex, and acrylic polymers. Specifically, from the viewpoint of unwinding adhesive force, at least one selected from the group consisting of unmodified natural rubber latex, acrylic-modified natural rubber latex, and an acrylic polymer is suitably used. In addition to the main agent, a known additive can be added to the pressure-sensitive adhesive composition as needed. Examples of the additive include tackifying resins such as rosin ester resins, terpene resins, aliphatic and aromatic hydrocarbon resins, softeners such as low molecular weight isoprene rubber (IR) and polyisobutylene, and antioxidants such as phenolic antioxidants.

The pressure-sensitive adhesive layer 104 is formed on the base material 102 by a known method. For example, it is formed by applying the pressure-sensitive adhesive composition onto the base material 102 using various coaters and drying the composition. Alternatively, a pressure-sensitive adhesive layer may be formed on a separator, and this may be transferred onto the base material 102. Therefore, in the obtained protective tape 10 for a wire harness of the present embodiment, the pressure-sensitive adhesive layer 104 contains natural rubber latex and an acrylic polymer. Specifically, from the viewpoint of the unwinding adhesive force, at least one selected from the group consisting of unmodified natural rubber latex, acrylic-modified natural rubber latex, and an acrylic polymer is contained. The pressure-sensitive adhesive layer 104 preferably has a thickness (adhesive thickness) of 5 μm or more and 50 μm or less.

The 10% modulus and the unwinding adhesive force of the protective tape 10 for a wire harness of the present embodiment can be controlled by appropriately adjusting the type, blending ratio, and thickness of raw material components for the base material 102 and the pressure-sensitive adhesive layer 104.

The protective tape 10 for a wire harness of the present embodiment may include a layer in addition to the base material 102 and the pressure-sensitive adhesive layer 104 as needed. For example, a primer layer such as nitrile rubber (NBR) may be provided between the base material 102 and the pressure-sensitive adhesive layer 104. When the primer layer is provided, adhesion of the pressure-sensitive adhesive layer 104 to the base material 102 can be improved.

### EXAMPLES

Hereinafter, the present invention will be further described with reference to examples and comparative examples, but the present invention is not limited to the following examples.

### Example 1

A nitrile rubber (NBR)-based primer layer and a rubber-based pressure-sensitive adhesive layer were formed on a base material containing polyvinyl chloride (PVC) having a thickness of 140 μm to obtain a protective tape for a wire harness. Specifically, the pressure-sensitive adhesive layer contained unmodified natural rubber latex and acrylic-modified natural rubber latex, and had a thickness of 5 μm or more and 50 μm or less. In addition, the 10% modulus (N/19 mm width) and the unwinding adhesive force (N/19 mm width) of the obtained protective tape 10 for a wire harness are listed in Table 1.

### Examples 2 to 6

A primer layer and a pressure-sensitive adhesive layer were formed on the base material to obtain a protective tape for a wire harness in the same manner as in Example 1 except that the thickness of the base material containing polyvinyl chloride (PVC), the blending ratio of the main agent contained in the pressure-sensitive adhesive layer, and the thickness of the pressure-sensitive adhesive layer were appropriately changed. The thickness of the pressure-sensitive adhesive layer was in a range of 5 μm or more and 50 μm or less. In addition, the 10% modulus (N/19 mm width) and the unwinding adhesive force (N/19 mm width) of the obtained protective tape 10 for a wire harness are listed in Table 1.

### Comparative Examples 1 to 5

A primer layer and a pressure-sensitive adhesive layer were formed on the base material to obtain a protective tape for a wire harness in the same manner as in Example 1 except that the thickness of the base material containing polyvinyl chloride (PVC), the blending ratio of the main agent contained in the pressure-sensitive adhesive layer, and the thickness of the pressure-sensitive adhesive layer were appropriately changed. The thickness of the pressure-sensitive adhesive layer was in a range of 5 μm or more and 50 μm or less. In addition, the 10% modulus (N/19 mm width) and the unwinding adhesive force (N/19 mm width) of the obtained protective tape 10 for a wire harness are listed in Table 1.

### Measurement Method

Tensile Test (10% modulus)

In accordance with JIS Z 0237, a protective tape for a wire harness (tape width: 19 mm) was pulled at a chuck distance of 100 mm and a speed of 5 mm/s using a tensile tester. After pulling, the strength at 10 mm (10%) elongation was read.

### Low-Speed Unwinding Adhesive Force

In accordance with JIS Z 0237, a protective tape for a wire harness wound in a roll was fitted into a roller of an attachment jig using a tensile tester, and was pulled at a speed of 5 mm/s. The measurement points were 3 points of 40 mm, 60 mm, and 80 mm, and an average value of the 3 points was calculated.

### Thickness

In accordance with JIS C 2107, using a dial gauge, 5 sheets of test pieces having a width of 19 mm were cut out from a roll, left for 5 minutes or longer to remove strain, then a surface on the gauge was gently lowered onto the surface of the test piece, and the minimum value was read. The thickness of a base material containing polyvinyl chloride (PVC) was previously determined in the same manner as described above. Then, the thickness of the pressure-sensitive adhesive layer was obtained by subtracting the thickness of the base material from the minimum value read for the test piece.

### Evaluation Method

### Workability Determination

Determination was made according to the following criteria based on the measurement result of low speed unwinding adhesive force.
O: 0.8 N/19 mm width or more and 4.5 N/19 mm width or less
X: Less than 0.8 N/19 mm width or more than 4.5 N/19 mm width

### End Peeling

The protective tape for a wire harness was wound around an electric wire bundle converged at $10 mm, and then was left at 80° C. for 4 hours. Thereafter, peeling at a tape end portion was confirmed.
O: Peeling of less than 1 mm was observed.
X: Peeling of 1 mm or more was observed.

### Abrasion Resistance

Two sheets of test pieces (protective tapes for wire harnesses) having an appropriate length were superposed (double-layered) on an aluminum pipe of $10 mm to be attached, and this was set in an abrasion resistance tester specified in JASO D 608, and a load of 4.4 N was applied to the test piece.

Then, an abrasive tape was moved at a speed of 1500 mm/min, and the tape length until the aluminum pipe and the tape were brought into contact with each other was read.
⊚: 450 mm or more
O: 300 mm or more and less than 450 mm
X: less than 300 mm

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | Exam- | Exam- | Exam- | Exam- | Exam- | Exam- | Exam- | Exam- | Exam- | Exam- | Exam- |
| Item | ple 1 | ple 2 | ple 3 | ple 4 | ple 5 | ple 6 | ple 1 | ple 2 | ple 3 | ple 4 | ple 5 |
| Base material | PVC | PVC | PVC | PVC | PVC | PVC | PVC | PVC | PVC | PVC | PVC |
| Thickness (μm) | 140 | 140 | 140 | 140 | 120 | 180 | 140 | 140 | 140 | 90 | 210 |
| Primer layer | NBR- | NBR- | NBR- | NBR- | NBR- | NBR- | NBR- | NBR- | NBR- | NBR- | NBR- |
| | based | based | based | based | based | based | based | based | based | based | based |
| Pressure- | Rubber- | Rubber- | Rubber- | Rubber- | Rubber- | Rubber- | Rubber- | Rubber- | Rubber- | Rubber- | Rubber- |
| sensitive | based | based | based | based | based | based | based | based | based | based | based |
| adhesive layer | | | | | | | | | | | |
| Modulus at 10% | 12.5 | 12.5 | 18.5 | 18.5 | 18.5 | 18.5 | 18.8 | 18.8 | 11.8 | 12.5 | 18.5 |
| elongation (N/19 | | | | | | | | | | | |
| mm) | | | | | | | | | | | |
| Unwinding | 0.8 | 4.5 | 0.8 | 4.5 | 4.5 | 4.5 | 4.9 | 0.5 | 4.9 | 0.8 | 0.8 |
| adhesive force | | | | | | | | | | | |
| (N/19 mm) | | | | | | | | | | | |
| Workability | ○ | ○ | ○ | ○ | ○ | ○ | × | × | × | ○ | ○ |
| determination | | | | | | | | | | | |
| End peeling | ○ | ○ | ○ | ○ | ○ | ○ | × | × | ○ | ○ | × |
| Abrasion | ⊚ | ⊚ | ⊚ | ⊚ | ○ | ⊚ | ⊚ | ⊚ | ⊚ | × | ⊚ |
| resistance | | | | | | | | | | | |

According to the protective tape for a wire harness of the present embodiment, effects of excellent tape winding workability, suppression of tape end peeling, and abrasion resistance are exhibited.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protective tape for a wire harness comprising:
a base material; and
a pressure-sensitive adhesive layer formed on the base material, wherein
the base material contains a thermoplastic resin and has a thickness of 120 μm or more and 190 μm or less,
a 10% modulus (N/19 mm width) is 12.5 or more and 18.5 or less, and
an unwinding adhesive force (N/19 mm width) is 0.8 or more and 4.5 or less.

2. The protective tape for a wire harness according to claim 1, wherein
the thermoplastic resin is at least one selected from the group consisting of polyvinyl chloride, polypropylene, and polyethylene.

3. The protective tape for a wire harness according to claim 1, wherein
the pressure-sensitive adhesive layer contains at least one selected from the group consisting of unmodified natural rubber latex, acrylic-modified natural rubber latex, and an acrylic polymer.

4. The protective tape for a wire harness according to claim 2, wherein
the pressure-sensitive adhesive layer contains at least one selected from the group consisting of unmodified natural rubber latex, acrylic-modified natural rubber latex, and an acrylic polymer.

5. The protective tape for a wire harness according to claim 1, wherein
the pressure-sensitive adhesive layer has a thickness of 5 μm or more and 50 μm or less.

6. The protective tape for a wire harness according to claim 2, wherein
the pressure-sensitive adhesive layer has a thickness of 5 μm or more and 50 μm or less.
